(19) United States
(12) Patent Application Publication
(10) Pub. No.: US 2025/0214484 A1
(43) Pub. Date: Jul. 3, 2025

(54) POWER SUPPLY CONTROL DEVICE

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Yuki NARITA, Yokkaichi-Shi, Mie (JP); Kazuki MASUDA, Yokkaichi-Shi (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/850,624

(22) PCT Filed: Mar. 31, 2022
(86) PCT No.: PCT/JP2022/016802

§ 371 Date: Sep. 25, 2024

(51) Int. Cl. B60L 58/16; B60L 58/18

(52) U.S. Cl. CPC B60L 58/16; B60L 58/18

(57) ABSTRACT

A power supply control device has a charging/discharging unit and a control unit that controls the charging/discharging unit. The charging/discharging unit performs a discharging operation for supplying power to a load based on power from a power storage unit, a regeneration operation for supplying power to a power supply unit based on power from the power storage unit, and a charging operation for supplying power to the power storage unit based on power from the power supply unit. The control unit determines the degree of degradation of the power storage unit, based on the value of a voltage of the power storage unit and the value of a current flowing through the power storage unit during at least one of the regeneration operation and the charging operation performed after the regeneration operation.

### CROSS-REFERENCE TO RELATED APPLICATIONS

This application is the U.S. national stage of PCT/JP2022/016802 filed on Mar. 31, 2022, the contents of which is incorporated herein.

### TECHNICAL FIELD

The present disclosure relates to a power supply control device.

### BACKGROUND

JP 2018-68019A discloses a backup device. This backup device is provided with a function of quickly performing discharging from a power storage unit (second power supply unit) when power supply from a power supply unit (first power supply unit) is interrupted. In a device provided with such a function, it is known to determine the degree of degradation (e.g., SOH: State Of Health) of the power storage unit. The degree of degradation is determined during charging or discharging of the power storage unit.

Since the power storage unit needs to be charged in preparation for use as backup, the power storage unit needs to be discharged beforehand in order to be charged. In other words, the power storage unit needs to be discharged in order to determine the degree of degradation, regardless of whether the degree of degradation is determined during charging or during discharging. It is, however, desirable to avoid wasteful power consumption when discharging the power storage unit.

The present disclosure provides a technology capable of determining the degree of degradation, while suppressing wasteful power consumption of a power storage unit.

### SUMMARY

A power supply control device of the present disclosure is a power supply control device to be installed in a vehicle and used in a power supply system including a power supply unit, a power path serving as a path for supplying power based on the power supply unit to a load, and a power storage unit functioning as a backup power supply at least when power supply from the power supply unit is interrupted, including: a charging/discharging unit configured to perform a discharging operation for supplying power to the load based on power from the power storage unit, a regeneration operation for supplying power to the power supply unit based on power from the power storage unit, and a charging operation for supplying power to the power storage unit based on power from the power supply unit; and a control unit configured to control the charging/discharging unit, the control unit determining a degree of degradation of the power storage unit, based on a value of a voltage of the power storage unit and a value of a current flowing through the power storage unit during at least one of the regeneration operation and the charging operation performed after the regeneration operation.

### Advantageous Effects

With the technology according to the present disclosure, the degree of degradation can be determined, while suppressing wasteful power consumption of a power storage unit.

### BRIEF DESCRIPTION OF DRAWINGS

FIG. 1 is a block diagram schematically illustrating a power supply system including a power supply control device according to the first embodiment.

FIG. 2 is an illustrative diagram conceptually showing operations of the power supply system at the time of a discharging operation.

FIG. 3 is an illustrative diagram conceptually showing operations of the power supply system at the time of a regeneration operation.

FIG. 4 is an illustrative diagram conceptually showing operations of the power supply system at the time of a charging operation.

FIG. 5 is a flowchart of processing performed by the power supply control device according to the first embodiment.

FIG. 6 is an illustrative diagram conceptually illustrating operations of a power supply system according to a second embodiment performed when a charging/discharging unit is controlled to perform the discharging operation during at least part of a period in which power is supplied from a power supply unit to a load.

FIG. 7 is part of a flowchart of processing performed by a power supply control device according to the second embodiment.

FIG. 8 is the remaining part of the flowchart of processing performed by the power supply control device according to the second embodiment.

### DETAILED DESCRIPTION OF PREFERRED EMBODIMENTS

Hereinafter, embodiments of the present disclosure will be enumerated and illustrated.

in a first aspect, a power supply control device to be installed in a vehicle and used in a power supply system including a power supply unit, a power path serving as a path for supplying power based on the power supply unit to a load, and a power storage unit functioning as a backup power supply at least when power supply from the power supply unit is interrupted, including: a charging/discharging unit configured to perform a discharging operation for supplying power to the load based on power from the power storage unit, a regeneration operation for supplying power to the power supply unit based on power from the power storage unit, and a charging operation for supplying power to the power storage unit based on power from the power supply unit; and a control unit configured to control the charging/discharging unit, the control unit determining a degree of degradation of the power storage unit, based on a value of a voltage of the power storage unit and a value of a current flowing through the power storage unit during at least one of the regeneration operation and the charging operation performed after the regeneration operation.

The power supply control device according to the first aspect performs the regeneration operation for supplying power to the power supply unit, based on power from the power storage unit. This power supply control device then determines the degree of degradation of the power storage unit, based on the value of the voltage of the power storage unit and the value of the current flowing through the power storage unit during at least one of the regeneration operation and the charging operation performed after the regeneration operation. Accordingly, this power supply control device is able to determine the degree of degradation, while suppressing wasteful power consumption of the power storage unit.

In a second aspect, the power supply control device according to the first aspect, in which the control unit controls the charging/discharging unit to perform the regeneration operation when a start switch for starting the vehicle switches off, and determines the degree of degradation of the power storage unit, based on the value of the voltage of the power storage unit and the value of the current flowing through the power storage unit during at least one of the regeneration operation and the charging operation performed after the regeneration operation.

The power supply control device according to the second aspect determines the degree of degradation by controlling the charging/discharging unit to perform the regeneration operation when the start switch of the vehicle switches off, and thus insufficient power supply from the power storage unit during travel of the vehicle can be readily avoided.

In a third aspect, the power supply control device according to the second aspect, in which the control unit controls the charging/discharging unit to perform the regeneration operation when the start switch switches off, until a predetermined regeneration end condition is established, controls the charging/discharging unit to perform the charging operation when the regeneration end condition is established, and determines the degree of degradation of the power storage unit, based on the value of the voltage of the power storage unit and the value of the current flowing through the power storage unit during at least one of the regeneration operation and the charging operation performed after the regeneration operation.

The power supply control device according to the third aspect controls the charging/discharging unit to perform the regeneration operation when the start switch of the vehicle switches off, and controls the charging/discharging unit to successively perform the charging operation after ending the regeneration operation. Accordingly, this power supply control device readily places the charging/discharging unit in a backup operation enabled state at the time of starting the vehicle.

In a fourth aspect, the power supply control device according to the first aspect, in which the control unit controls the charging/discharging unit to perform the regeneration operation when a start switch for starting the vehicle is on, and determines the degree of degradation of the power storage unit, based on the value of the voltage of the power storage unit and the value of the current flowing through the power storage unit during at least one of the regeneration operation and the charging operation performed after the regeneration operation.

The power supply control device according to the fourth aspect is able to determine the degree of degradation, while suppressing wasteful power consumption of the power storage unit, during travel of the vehicle.

In a fifth aspect, the power supply control device according to any one of the first through the fourth aspects, in which the control unit controls the charging/discharging unit to perform the regeneration operation, such that a discharge current from the charging/discharging unit is constant, and determines the degree of degradation of the power storage unit, based on the value of the voltage of the power storage unit and the value of the current flowing through the power storage unit during the regeneration operation.

The power supply control device according to the fifth aspect is able to determine the degree of degradation of the power storage unit, while performing the regeneration operation at a constant current.

In a sixth aspect, the power supply control device according to any one of the first through the fourth aspects, in which the control unit controls the charging/discharging unit to perform the charging operation, such that a charge current from the charging/discharging unit is constant, and determines the degree of degradation of the power storage unit, based on the value of the voltage of the power storage unit and the value of the current flowing through the power storage unit during the charging operation.

The power supply control device according to the sixth aspect is able to determine the degree of degradation of the power storage unit, while performing the charging operation at a constant current.

In a seventh aspect, a power supply control device to be installed in a vehicle and used in a power supply system including a power supply unit, a power path serving as a path for supplying power based on the power supply unit to a load, and a power storage unit functioning as a backup power supply at least when power supply from the power supply unit is interrupted, including: a charging/discharging unit configured to perform a discharging operation for supplying power to the load based on power from the power storage unit and a charging operation for supplying power to the power storage unit based on power from the power supply unit; and a control unit configured to control the charging/discharging unit, the control unit controlling the charging/discharging unit to perform the discharging operation during at least part of a period in which power is supplied from the power supply unit to the load, and determining a degree of degradation of the power storage unit, based on a value of a voltage of the power storage unit and a value of a current flowing through the power storage unit during at least one of the discharging operation and the charging operation performed after the discharging operation.

The power supply control device according to the seventh aspect controls the charging/discharging unit to perform the discharging operation during at least part of a period in which power is supplied from the power supply unit to the load. The discharge current from the charging/discharging unit is thus effectively utilized in operations of the load. This power supply control device then determines the degree of degradation of the power storage unit, based on the value of the voltage of the power storage unit and the value of the current flowing through the power storage unit during at least one of this discharging operation and the charging operation performed after this discharging operation. Accordingly, this power supply control device is able to determine the degree of degradation, while suppressing wasteful power consumption of the power storage unit.

In an eighth aspect, the power supply control device according to the seventh aspect, in which the control unit controls the charging/discharging unit to perform the discharging operation, such that an output voltage of the charging/discharging unit is higher than an output voltage of the power supply unit, during the at least part of the period, and determines the degree of degradation of the power storage unit, based on the value of the voltage of the power storage unit and the value of the current flowing through the power storage unit during at least one of the discharging operation and the charging operation performed after the discharging operation.

The power supply control device according to the eighth aspect is able to more reliably supply power from the power storage unit to the load during the period in which power is supplied from the power supply unit to the load.

In a ninth aspect, the power supply control device according to the seventh or the eighth aspects, in which the load outputs a permission signal for permitting discharging from the power storage unit to the load, and the control unit, having received the permission signal, controls the charging/discharging unit to perform the discharging operation, and determines the degree of degradation of the power storage unit, based on the value of the voltage of the power storage unit and the value of the current flowing through the power storage unit during at least one of the discharging operation and the charging operation performed after the discharging operation.

The power supply control device according to the ninth aspect starts the discharging operation after receiving the permission signal from the load, and thus the discharging operation is readily performed at a timing at which the load requires power supply.

In a tenth aspect, the power supply control device according to any one of the seventh through the ninth aspects, in which the control unit controls the charging/discharging unit to perform the discharging operation, such that a discharge current from the charging/discharging unit is constant during the at least part of the period, and determines the degree of degradation of the power storage unit, based on the value of the voltage of the power storage unit and the value of the current flowing through the power storage unit during the discharging operation.

The power supply control device according to the tenth aspect is able to determine the degree of degradation of the power storage unit, while supplying a constant current to the load.

In an eleventh aspect, the power supply control device according to any one of the seventh through the ninth aspects, in which the control unit controls the charging/discharging unit to perform the charging operation, such that a charge current supplied to the power storage unit is constant, and determines the degree of degradation of the power storage unit, based on the value of the voltage of the power storage unit and the value of the current flowing through the power storage unit during the charging operation.

The power supply control device according to the eleventh aspect is able to determine the degree of degradation of the power storage unit, while performing the charging operation at a constant current.

### First Embodiment

### Overview of Power Supply System 1

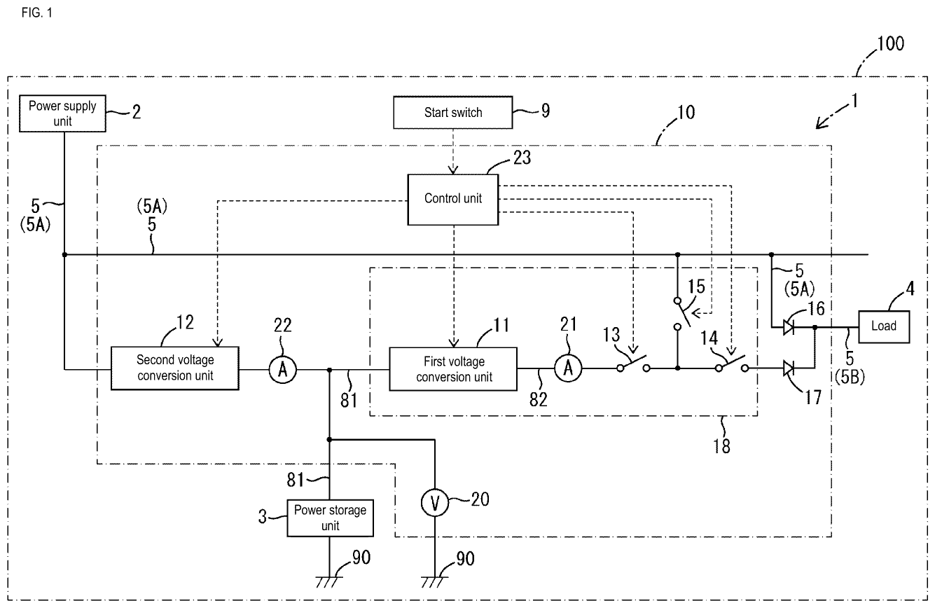

FIG. 1 shows a power supply system 1 provided with a power supply control device 10 according to a first embodiment. The power supply system 1 is installed in a vehicle 100 and can supply power to various loads. The vehicle 100 in which the power supply system 1 is installed is, for example, a vehicle such as an electric vehicle, a plug-in hybrid vehicle, or a hybrid vehicle, or may be another type of vehicle.

As shown in FIG. 1, the power supply system 1 is installed in the vehicle 100. In FIG. 1, the region of the vehicle 100 is conceptually shown with a frame indicated by a one-dot chain line. The power supply system 1 is provided with a power supply unit 2, a power storage unit 3, a load 4, a power path 5, a start switch 9, and the power supply control device 10.

The power supply unit 2 is an in-vehicle power supply that can supply power to the load 4. The power supply unit 2 is constituted as a known in-vehicle battery such as a lead battery, for example. The power supply unit 2 may be constituted by a battery other than a lead battery, and may have a power supply means other than a battery, instead of or in addition to the battery. A positive electrode of the power supply unit 2 is electrically connected to the power path 5 in a configuration where the positive electrode is directly connected to the power path 5. A negative electrode of the power supply unit 2 is electrically connected to a ground 90 in a configuration where the negative electrode is directly connected to the ground 90. The power supply unit 2 applies a predetermined DC voltage (e.g., 12 V) to the power path 5 when fully charged. The power supply unit 2 supplies power to the power path 5 and supplies power to the load 4 via the power path 5.

The power storage unit 3 functions as a backup power supply at least when power supply from the power supply unit 2 is interrupted. The power storage unit 3 may be provided with a capacitor (e.g., electric double layer capacitor (EDLC) or a lithium-ion capacitor (LiC)), or with a battery, or with another power storage means. A positive electrode of the power storage unit 3 is electrically connected to a first conduction path 81 in a configuration where the positive electrode is directly connected to the first conduction path 81. A negative electrode of the power storage unit 3 is electrically connected to the ground 90 in a configuration where the negative electrode is directly connected to the ground 90. The voltage of the power storage unit 3 may be larger or smaller than the voltage of the power supply unit 2. The voltage of the power storage unit 3 is the voltage applied to the first conduction path 81 by the power storage unit 3. The voltage of the power storage unit 3 is synonymous with the output voltage of the power storage unit 3 and with the charge voltage of the power storage unit 3. The voltage of the power supply unit 2 is the voltage applied to the power path 5 by the power supply unit 2. The voltage of the power supply unit 2 is synonymous with the output voltage of the power supply unit 2 and with the charge voltage of the power supply unit 2. The power storage unit 3 supplies power to the load 4 via the power path 5, at least when power supply from the power supply unit 2 is interrupted.

In the present disclosure, a voltage is a voltage relative to a ground potential (e.g., 0 V) and is the potential difference from the ground potential, unless otherwise stated. For example, the voltage applied to the power path 5 is the potential difference between the potential of the power path 5 and the ground potential.

The load 4 is an electrical component installed in the vehicle 100. The load 4 operates by receiving power supplied via the power path 5.

The power path 5 is the path through which power based on the power supply unit 2 is transmitted, and the path for supplying power based on the power supply unit 2 to the load 4. The power path 5 has an input-side power path 5A and an output-side power path 5B disposed on the load 4 side of the input-side power path 5A. In the example shown in FIG. 1, a voltage that is the same as or substantially the same as the voltage of the power supply unit 2 is applied to the power path 5 (more specifically, input-side power path 5A). One end of the power path 5 (more specifically, one end of input-side power path 5A) is electrically connected to the positive electrode of the power supply unit 2 in a configuration where the one end is directly connected to the positive electrode. The other end of the power path 5 (more specifically, other end of output-side power path 5B) is electrically connected to one end of the load 4 in a configuration where the other end is directly connected to the one end. A relay or a fuse may be provided on the power path 5.

If the vehicle 100 is a plug-in hybrid vehicle or a hybrid vehicle, for example, the start switch 9 corresponds to an ignition switch for starting an engine. If the vehicle 100 is an electric vehicle, the start switch 9 corresponds to a power switch for starting an EV system.

### Configuration of Power Supply Control Device 10

The power supply control device 10 is used in the power supply system 1. The power supply control device 10 is installed in the vehicle 100. The power supply control device 10 has a first voltage conversion unit 11, a second voltage conversion unit 12, switches 13, 14, and 15, diodes 16 and 17, a voltage detection unit 20, a first current detection unit 21, a second current detection unit 22, a control unit 23, the first conduction path 81, and a second conduction path 82.

The first voltage conversion unit 11 is a device that performs voltage conversion between the first conduction path 81 and the second conduction path 82. The first voltage conversion unit 11 is constituted by a known voltage conversion circuit such as a DC-DC converter, for example. The first voltage conversion unit 11 can perform a first conversion operation for stepping down or stepping up the DC voltage applied to the first conduction path 81 and applying an output voltage to the second conduction path 82. The first voltage conversion unit 11 can perform a second conversion operation for stepping down or stepping up the DC voltage applied to the second conduction path 82 and applying an output voltage to the first conduction path 81. Operations of the first voltage conversion unit 11 are controlled by the control unit 23.

The switches 13, 14, and 15 are each constituted by a semiconductor switch such as a FET (Field Effect Transistor) or a mechanical relay. One end of the switch 13 is electrically connected to the second conduction path 82. The other end of the switch 13 is electrically connected to one end of the switch 14 and one end of the switch 15. The other end of the switch 14 is electrically connected to an anode of the diode 17 and is electrically connected to the output-side power path 5B via the diode 17. The other end of the switch 15 is electrically connected to the input-side power path 5A. Operations of the switches 13, 14, and 15 are controlled by the control unit 23.

An anode of the diode 16 is electrically connected to the other end of the input-side power path 5A. A cathode of the diode 16 is electrically connected to one end of the output-side power path 5B. The anode of the diode 17 is electrically connected to the other end of the switch 14. A cathode of the diode 17 is electrically connected to the output-side power path 5B.

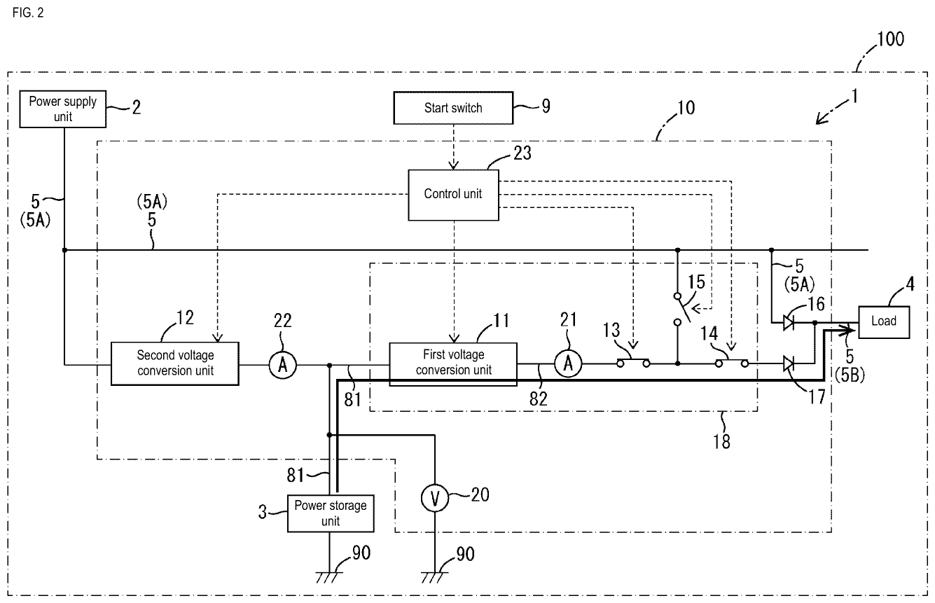

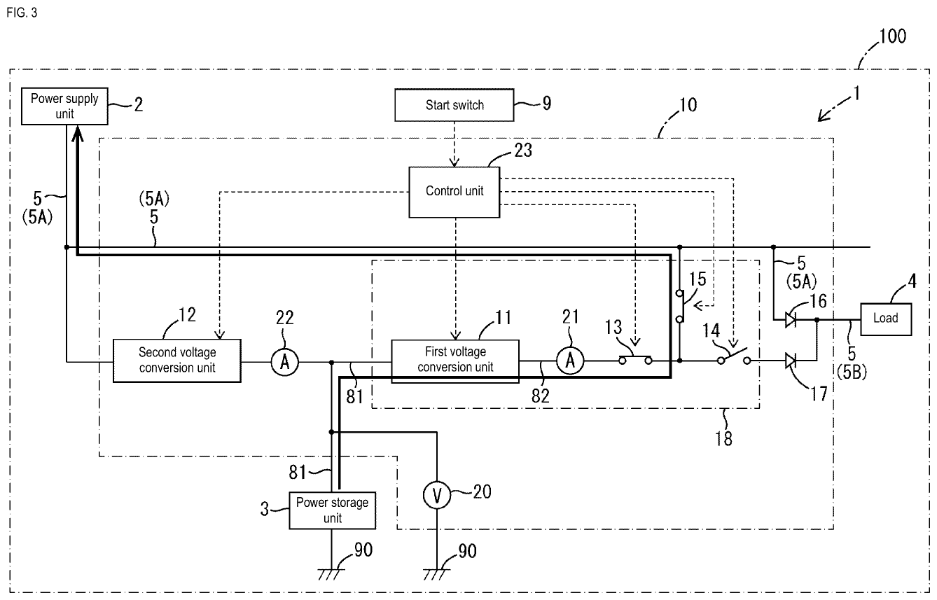

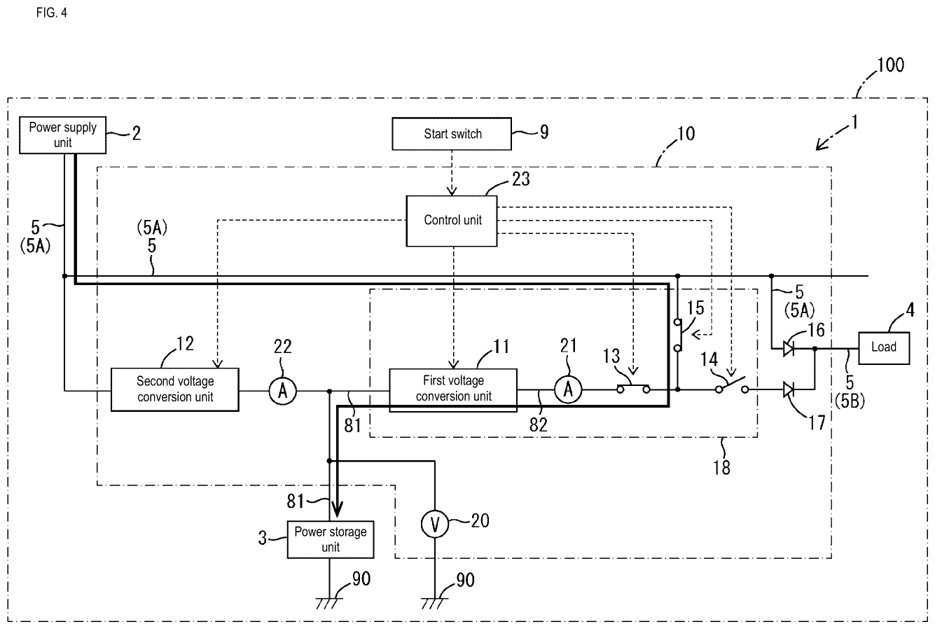

The first voltage conversion unit 11 and the switches 13, 14, and 15 constitute a charging/discharging unit 18. The charging/discharging unit 18 performs a discharging operation for supplying power to the load 4, based on power from the power storage unit 3. As shown in FIG. 2, the charging/discharging unit 18 performs the discharging operation, as a result of the first voltage conversion unit 11 performing the first conversion operation, the switches 13 and 14 switching on, and the switch 15 switching off. The charging/discharging unit 18 performs a regeneration operation for supplying power to the power supply unit 2, based on power from the power storage unit 3. As shown in FIG. 3, the charging/discharging unit 18 performs the regeneration operation, as a result of the first voltage conversion unit 11 performing the first conversion operation, the switches 13 and 15 switching on, and the switch 14 switching off. The charging/discharging unit 18 performs a charging operation for supplying power to the power storage unit 3, based on power from the power supply unit 2. As shown in FIG. 4, the charging/discharging unit 18 performs the charging operation, as a result of the first voltage conversion unit 11 performing the second conversion operation, the switches 13 and 15 switching on, and the switch 14 switching off.

The second voltage conversion unit 12 is a device that performs voltage conversion between the first conduction path 81 and the power path 5 (more specifically, input-side power path 5A). The second voltage conversion unit 12 is constituted by a known voltage conversion circuit such as a DC-DC converter, for example. The second voltage conversion unit 12 can perform a third conversion operation for stepping down or stepping up the DC voltage applied to the first conduction path 81 and applying an output voltage to the power path 5 (more specifically, input-side power path 5A). The second voltage conversion unit 12 can perform a fourth conversion operation for stepping down or stepping up the DC voltage applied to the power path 5 (more specifically, input-side power path 5A) and applying an output voltage to the first conduction path 81. The second voltage conversion unit 12 is used for charging and discharging small amounts of power compared to the first voltage conversion unit 11. Operations of the second voltage conversion unit 12 is controlled by the control unit 23.

The voltage detection unit 20 can detect the voltage of the power storage unit 3. The voltage detection unit 20 is constituted as a known voltage detection circuit, for example. The voltage detection unit 20 may or may not divide the detected value. The voltage detection unit 20 outputs, to the control unit 23, a signal capable of specifying the voltage of the power storage unit 3.

The first current detection unit 21 can detect the value of the current flowing through the power storage unit 3 when the first voltage conversion unit 11 is performing the first conversion operation or the second conversion operation. In other words, the first current detection unit 21 can detect the value of the current flowing through the power storage unit 3 at the time of the discharging operation, the regeneration operation, and the charging operation. The first current detection unit 21 is constituted using a shunt resistor or a current transformer, for example. The first current detection unit 21 outputs, to the control unit 23, a signal capable of specifying the value of the current flowing through the power storage unit 3.

The second current detection unit 22 can detect the value of the current flowing through the power storage unit 3 when the second voltage conversion unit 12 is performing the third conversion operation or the fourth conversion operation. The second current detection unit 22 is constituted using a shunt resistor or a current transformer, for example. The second current detection unit 22 outputs, to the control unit 23, a signal capable of specifying the value of the current flowing through the power storage unit 3.

The control unit 23 is provided with a control device. This control device is an information processing device having a computational function and an information processing function, and has, for example, a CPU, a storage unit, and the like. The control unit 23 can acquire the value of the voltage of the power storage unit 3, based on the signal from the voltage detection unit 20. The control unit 23 can acquire the value of the current flowing through the power storage unit 3, based on the signal from the first current detection unit 21. The control unit 23 can acquire the value of the current flowing through the power storage unit 3, based on the signal from the second current detection unit 22. The control unit 23 can control operations of the first voltage conversion unit 11, the second voltage conversion unit 12, and the switches 13, 14, and 15. The control unit 23 can control operations of the charging/discharging unit 18.

The control unit 23 determines the degree of degradation of the power storage unit 3, based on the value of the voltage of the power storage unit 3 and the value of the current flowing through the power storage unit 3 during the charging operation performed after the regeneration operation. The control unit 23 determines the degree of degradation of the power storage unit 3, based on the value of the voltage of the power storage unit 3 acquired based on the signal from the voltage detection unit 20 and the value of the current flowing through the power storage unit 3 acquired based on the signal from the first current detection unit 21. In the present embodiment, the degree of degradation is SOH (State Of Health), or, more specifically, SOHR. SOHR is the rate of increase in the internal resistance of the power storage unit 3. SOHR is calculated by the following equation (1).

$$SOHR = R / R 0 \qquad ( 1 )$$

R is the current internal resistance of the power storage unit 3. R0 is the internal resistance of the power storage unit 3 at the start of use or the initial internal resistance of the power storage unit 3. R0 may be stored in advance in the control unit 23 or may be calculated at the start of use.

R is calculated by the following equation (2).

$$R = ( V 2 - V 1 ) / ( I 2 - I 1 ) \qquad ( 2 )$$

V1 is the value of the voltage of the power storage unit 3 at the start of determination (start of charging operation in the present embodiment). V2 is the value of the voltage of the power storage unit 3 at the end of determination (end of charging operation in the present embodiment). I1 is the current value (0 A in the present embodiment) flowing through the power storage unit 3 at the start of determination (start of charging operation in the present embodiment). I2 is the value of the current flowing through the power storage unit 3 at the end of determination (end of charging operation in the present embodiment). A determination time Tc from the start of determination to the end of determination is set to the time required for determining the degree of degradation.

The control unit 23 controls the charging/discharging unit 18 to perform the regeneration operation when the start switch 9 switches from on to off, and determines the degree of degradation of the power storage unit 3, based on the value of the voltage of the power storage unit 3 and the value of the current flowing through the power storage unit 3 during the charging operation performed after the regeneration operation.

The control unit 23 controls the charging/discharging unit 18 to perform the regeneration operation when the start switch 9 switches from on to off, until a predetermined regeneration end condition is established. In the present embodiment, the regeneration end condition is that the value of the voltage of the power storage unit 3 has fallen to less than or equal to a predetermined charging start voltage Vc. The charging start voltage Vc is set such that the time necessary for determining the degree of degradation is secured in the case of performing the charging operation until the value of the voltage of the power storage unit 3 reaches a charging target voltage. When the regeneration end condition is established, the control unit 23 controls the charging/discharging unit 18 to perform the charging operation, and determines the degree of degradation of the power storage unit 3, based on the value of the voltage of the power storage unit 3 and the value of the current flowing through the power storage unit 3 during the charging operation.

The control unit 23 performs the charging operation, such that the charge current from the charging/discharging unit 18 is constant, and determines the degree of degradation of the power storage unit 3, based on the value of the voltage of the power storage unit 3 and the value of the current flowing through the power storage unit 3 during the charging operation.

### Specific Example of Operations of the Power Supply Control Device 10

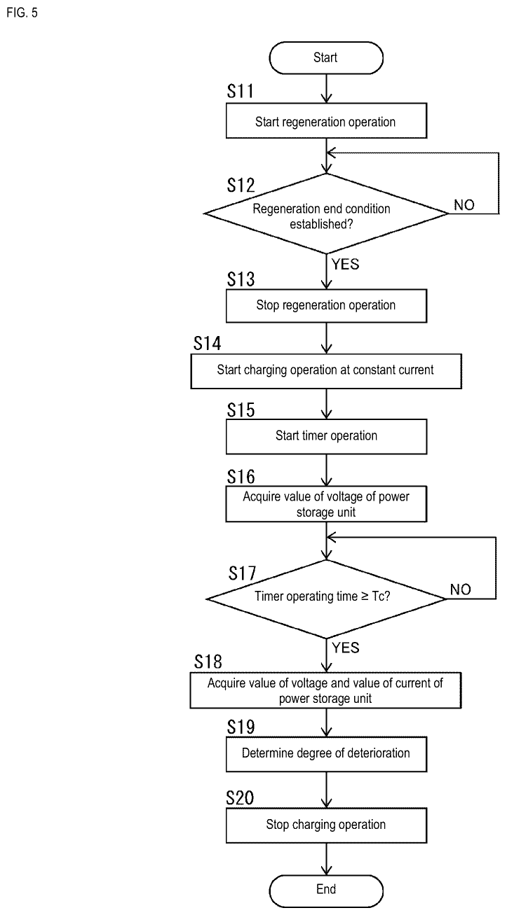

The control unit 23 performs the processing of the flowchart shown in FIG. 5 when the start switch 9 switches from on to off, for example. First, the control unit 23, in step S11, controls the charging/discharging unit 18 to start the regeneration operation. In step S12, the control unit 23 determines whether the regeneration end condition is established. If it is determined that the regeneration end condition is not established (if NO in step S12), the control unit 23 returns the processing to step S12. In other words, the control unit 23 controls the charging/discharging unit 18 to continue performing the regeneration operation, until the regeneration end condition is established.

If it is determined that the regeneration end condition is established (if YES in step S12), the control unit 23, in step S13, controls the charging/discharging unit 18 to stop the regeneration operation, and, in step S14, controls the charging/discharging unit 18 to start the charging operation at a constant current. In step S15, the control unit 23 starts operation of a timer and starts measuring the time that has elapsed from when the charging operation is started (elapsed time from start of determination). In step S16, the control unit 23 acquires the value of the voltage of the power storage unit 3 at the start of determination (start of charging operation).

In step S17, the control unit 23 determines whether the operating time of the timer is greater than or equal to the determination time Tc. If it is determined that the operating time of the timer is not greater than or equal to the determination time Tc (if NO in step S17), the control unit 23 returns the processing to step S17. In other words, the control unit 23 controls the charging/discharging unit 18 to continue performing the charging operation, until the operating time of the timer is greater than or equal to the determination time Tc.

If it is determined that the operating time of the timer is greater than or equal to the determination time Tc (if YES in step S17), the control unit 23, in step S18, acquires the value of the voltage of the power storage unit 3 and the value of the current flowing through the power storage unit 3 at the end of determination (end of charging operation). In step S19, the control unit 23 determines the degree of degradation of the power storage unit 3. The control unit 23 determines the degree of degradation, based on the value of the voltage of the power storage unit 3 acquired in step S16 and the value of the voltage of the power storage unit 3 and the value of the current flowing through the power storage unit 3 acquired in step S18. In step S20, the control unit 23 stops the charging operation. Thereafter, the control unit 23 ends the processing shown in FIG. 5.

### Examples of Effects

The power supply control device 10 performs the regeneration operation for supplying power to the power supply unit 2, based on power from the power storage unit 3. The power supply control device 10 then determines the degree of degradation of the power storage unit 3, based on the value of the voltage of the power storage unit 3 and the value of the current flowing through the power storage unit 3 during the charging operation performed after the regeneration operation. Accordingly, the power supply control device 10 is able to determine the degree of degradation, while suppressing wasteful power consumption of the power storage unit 3.

Furthermore, the power supply control device 10 determines the degree of degradation by controlling the charging/discharging unit 18 to perform the regeneration operation when the start switch 9 of the vehicle 100 switches off, and thus insufficient power supply from the power storage unit 3 during travel of the vehicle 100 can be readily avoided.

Furthermore, the power supply control device 10 controls the charging/discharging unit 18 to perform the regeneration operation when the start switch 9 of the vehicle 100 switches off, and controls the charging/discharging unit 18 to successively perform the charging operation after ending the regeneration operation. Accordingly, this power supply control device 10 readily places the charging/discharging unit 18 in a backup operation enabled state at the time of starting the vehicle 100.

Furthermore, the power supply control device 10 is able to determine the degree of degradation of the power storage unit 3, while performing the charging operation at a constant current.

### Second Embodiment

A power supply control device according to a second embodiment controls a charging/discharging unit to perform a discharging operation during at least part of a period in which power is supplied from a power supply unit to a load, and determines the degree of degradation of a power storage unit, based on the value of the voltage of the power storage unit and the value of the current flowing through the power storage unit during the discharging operation. Note that a power supply system according to the second embodiment is the same as the power supply system shown in FIG. 1. Hereinafter, the second embodiment will be described using FIG. 1.

The control unit 23 controls the charging/discharging unit 18 to perform the discharging operation during at least part of the period in which power is supplied from the power supply unit 2 to the load 4, and determines the degree of degradation of the power storage unit 3, based on the value of the voltage of the power storage unit 3 and the value of the current flowing through the power storage unit 3 during the discharging operation. The control unit 23 determines the degree of degradation of the power storage unit 3, based on the value of the voltage of the power storage unit 3 acquired based on the signal from the voltage detection unit 20 and the value of the current flowing through the power storage unit 3 acquired based on the signal from the first current detection unit 21.

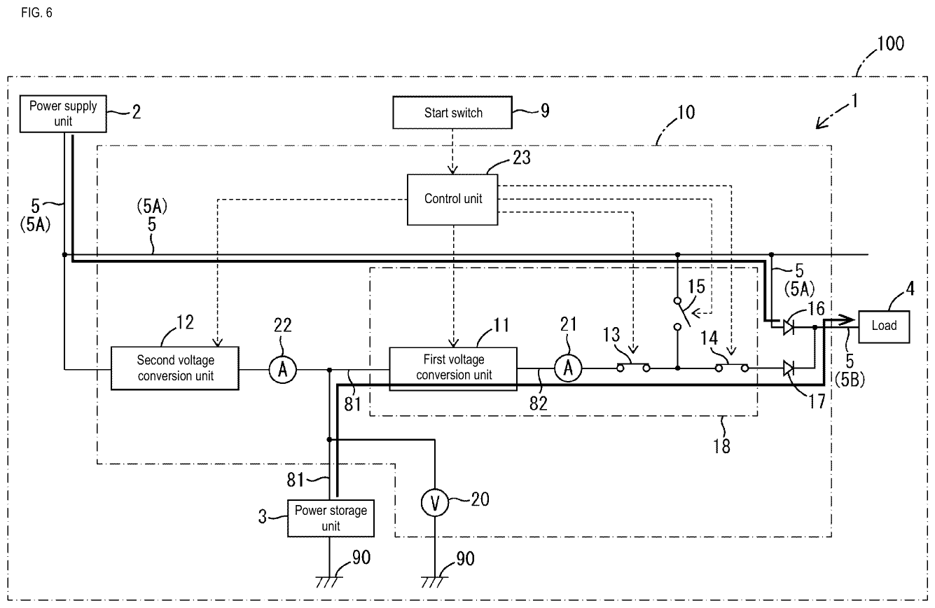

The control unit 23 controls the charging/discharging unit 18 to perform the discharging operation, such that the output voltage of the charging/discharging unit 18 is higher than the output voltage of the power supply unit 2, during the at least part of the above period. As shown in FIG. 6, power supply from the charging/discharging unit 18 is thereby prioritized over power supply from the power supply unit 2. The control unit 23 determines the degree of degradation of the power storage unit 3, based on the value of the voltage of the power storage unit 3 and the value of the current flowing through the power storage unit 3 during this discharging operation.

The load 4 has a control circuit and an output unit that outputs a signal externally. The load 4 outputs a permission signal for permitting discharging from the power storage unit 3 to the load 4, when performing a predetermined operation. The permission signal is input to the power supply control device 10.

The control unit 23, having received the permission signal, controls the charging/discharging unit 18 to perform the discharging operation, and determines the degree of degradation of the power storage unit 3, based on the value of the voltage of the power storage unit 3 and the value of the current flowing through the power storage unit 3 during the discharging operation.

The control unit 23 controls the charging/discharging unit 18 to perform the discharging operation, such that the discharge current, from the charging/discharging unit 18 is constant during the at least part of the above period, and determines the degree of degradation of the power storage unit 3, based on the value of the voltage of the power storage unit 3 and the value of the current flowing through the power storage unit 3 during the discharging operation.

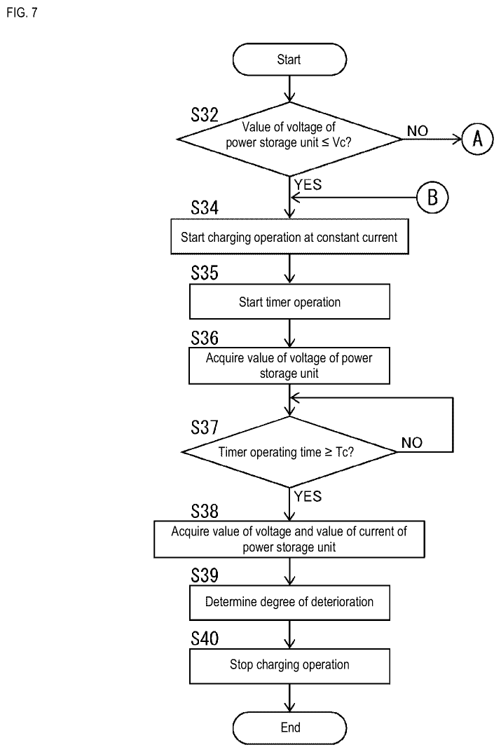

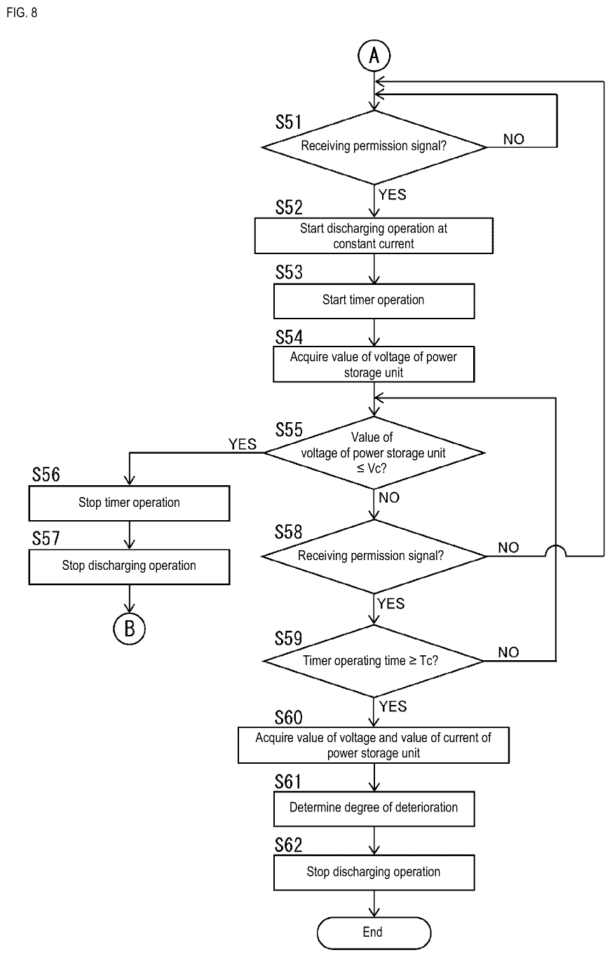

The control unit 23 performs the processing of the flowchart shown in FIGS. 7 and 8, when the start switch 9 switches from off to on, for example. First, in step S32, the control unit 23 determines whether the value of the voltage of the power storage unit 3 is less than or equal to the charging start voltage Vc. If it is determined that the value of the voltage of the power storage unit 3 is less than or equal to the charging start voltage Vc (if YES in step S32), the control unit 23, in step S34, controls the charging/discharging unit 18 to start the charging operation. At this time, the control unit 23 controls the charging/discharging unit 18 to perform the charging operation, such that the charge current from the charging/discharging unit 18 is constant. In step S35, the control unit 23 starts operation of the timer and starts measuring the time that has elapsed from when the charging operation is started (elapsed time from start of determination). In step S36, the control unit 23 acquires the value of the voltage of the power storage unit 3 at the start of determination (start of charging operation).

In step S37, the control unit 23 determines whether the operating time of the timer is greater than or equal to the determination time Tc. If it is determined that the operating time of the timer is not greater than or equal to the determination time Tc (if NO in step S37), the control unit 23 returns the processing to step S37. In other words, the control unit 23 controls the charging/discharging unit 18 to continue performing the charging operation, until the operating time of the timer is greater than or equal to the determination time Tc.

If it is determined that the operating time of the timer is greater than or equal to the determination time Tc (if YES in step S37), the control unit 23, in step S38, acquires the value of the voltage of the power storage unit 3 and the value of the current flowing through the power storage unit 3 at the end of determination (end of charging operation). The control unit 23, in step S39, determines the degree of degradation of the power storage unit 3. The control unit 23 determines the degree of degradation, based on the value of the voltage of the power storage unit 3 acquired in step S36 and the value of the voltage of the power storage unit 3 and the value of the current flowing through the power storage unit 3 acquired in step S38. In step S40, the control unit 23 controls the charging/discharging unit 18 to stop the charging operation. Thereafter, the control unit 23 ends the processing shown in FIGS. 7 and 8.

If it is determined in step S32 that the value of the voltage of the power storage unit 3 is not less than or equal to the charging start voltage Vc, the control unit 23 determines, in step S51 of FIG. 8, whether the permission signal is being received. If the permission signal is not being received (if NO in step S51), the control unit 23 waits until the permission signal is received.

If it is determined that the permission signal is being received (if YES in step S51), the control unit 23, in step S52, controls the charging/discharging unit 18 to start the discharging operation. At this time, the control unit 23 controls the charging/discharging unit 18 to perform the discharging operation, such that the discharge current from the charging/discharging unit 18 is constant. In step S53, the control unit 23 starts operation of the timer and measures the time that has elapsed from when the discharging operation is started (elapsed time from start of determination). In step S54, the control unit 23 acquires the value of the voltage of the power storage unit 3 at the start of determination (start of discharging operation).

In step S55, the control unit 23 determines whether the value of the voltage of the power storage unit 3 is less than or equal to the charging start voltage Vc. If it is determined that the value of the voltage of the power storage unit 3 is less than or equal to the charging start voltage Vc (if YES in step S55), the control unit 23 stops operation of the timer (step S56), stops the discharging operation (step S57), and transitions the processing to step S34 in FIG. 7. In other words, the control unit 23 controls the charging/discharging unit 18 to start the charging operation, and determines the degree of degradation of the power storage unit 3, based on the value of the voltage of the power storage unit 3 and the value of the current flowing through the power storage unit 3 during the charging operation.

If it is determined that the value of the voltage of the power storage unit 3 is not less than or equal to the charging start voltage Vc (if NO in step S55), the control unit 23, in step S58, determines whether the permission signal is being received. If it is determined that the permission signal is not being received (if NO in step S58), the control unit 23 returns the processing to step S51.

If it is determined that the permission signal is being received (if YES in step S58), the control unit 23, in step S59, determines whether the operating time of the timer is greater than or equal to the determination time Tc. In other words, the control unit 23 determines whether the time that has elapsed from when the discharging operation is started (elapsed time from the start of determination) is greater than or equal to the determination time Tc. If it is determined that the operating time of the timer is not greater than or equal to the determination time Tc (if NO in step S59), the control unit 23 returns the processing to step S55. In other words, if it is determined that the value of the voltage of the power storage unit 3 has fallen to less than or equal to the charging start voltage Vc during the discharging operation, the control unit 23 switches to the charging operation, and determines the degree of degradation of the power storage unit 3, based on the value of the voltage of the power storage unit 3 and the value of the current flowing through the power storage unit 3 during the charging operation.

If it is determined that the operating time of the timer is greater than or equal to the determination time Tc (if YES in step S59), the control unit 23, in step S60, acquires the value of the voltage of the power storage unit 3 and the value of the current flowing through the power storage unit 3 at the end of determination (end of discharging operation). The control unit 23, in step S61, then determines the degree of degradation of the power storage unit 3. The control unit 23 determines the degree of degradation, based on the value of the voltage of the power storage unit 3 acquired in step S54 and the value of the voltage of the power storage unit 3 and the value of the current flowing through the power storage unit 3 acquired in step S60. The control unit 23, in step S62, controls the charging/discharging unit 18 to stop the discharging operation. Thereafter, the control unit 23 ends the processing shown in FIGS. 7 and 8.

As described above, the power supply control device 10 according to the second embodiment controls the charging/discharging unit 18 to perform the discharging operation during at least part of the period in which power is supplied from the power supply unit 2 to the load 4. The discharge current from the charging/discharging unit 18 is thus effectively utilized in operations of the load 4. The power supply control device 10 then determines the degree of degradation of the power storage unit 3, based on the value of the voltage of the power storage unit 3 and the value of the current flowing through the power storage unit 3 during this discharging operation. Accordingly, the power supply control device 10 is able to determine the degree of degradation, while suppressing wasteful power consumption of the power storage unit 3.

Furthermore, the control unit 23 controls the charging/discharging unit 18 to perform the discharging operation, such that the output voltage of the charging/discharging unit 18 is higher than the output voltage of the power supply unit 2, during the at least part of the above period, and determines the degree of degradation of the power storage unit 3, based on the value of the voltage of the power storage unit 3 and the value of the current flowing through the power storage unit 3 during this discharging operation. Accordingly, the power supply control device 10 is able to more reliably supply power from the power storage unit 3 to the load 4, during the period in which power is supplied from the power supply unit 2 to the load 4.

Furthermore, the power supply control device 10 starts the discharging operation after receiving the permission signal from the load 4, and thus the discharging operation is readily performed at a timing at which the load 4 requires power supply.

Furthermore, the power supply control device 10 is able to determine the degree of degradation of the power storage unit 3, while supplying a constant current to the load 4.

### OTHER EMBODIMENTS

The present disclosure is not limited to the embodiments illustrated in the above description and drawings. For example, the features of the above-described or later-described embodiments can be combined in any manner provided there are no inconsistencies. Any features of the above-described or later-described embodiments can also be omitted if not specified as essential. Furthermore, the above-described embodiments can be modified as follows.

In the first embodiment, the degree of degradation is determined during the charging operation performed after the regeneration operation, but a configuration may be adopted in which the degree of degradation is determined during the regeneration operation. In this case, the charging/discharging unit is preferably controlled to perform the regeneration operation, such that the discharge current from the charging/discharging unit is constant.

In the first embodiment, the degree of degradation is determined when the start switch is off, but a configuration may be adopted in which the degree of degradation is determined when the start switch is on.

In the second embodiment, the degree of degradation is determined during the discharging operation to the load, but a configuration may be adopted in which the degree of degradation is determined during the charging operation performed after this discharging operation. In this case, the charging/discharging unit is preferably controlled to perform the charging operation, such that the charge current supplied to the power storage unit is constant.

Note that the embodiments disclosed herein are to be considered in all respects as illustrative and not restrictive. The scope of the disclosure is not limited to the embodiments disclosed herein, and all changes that come within the range indicated by the claims or the range of equivalency of the claims are intended to be embraced therein.

1. A power supply control device to be installed in a vehicle and used in a power supply system including a power supply unit, a power path serving as a path for supplying power based on the power supply unit to a load, and a power storage unit functioning as a backup power supply at least when power supply from the power supply unit is interrupted, comprising:
a charging/discharging unit configured to perform a discharging operation for supplying power to the load based on power from the power storage unit, a regeneration operation for supplying power to the power supply unit based on power from the power storage unit, and a charging operation for supplying power to the power storage unit based on power from the power supply unit; and
a control unit configured to control the charging/discharging unit,
the control unit controlling the charging/discharging unit to perform the regeneration operation when a start switch for starting the vehicle switches off, until a predetermined regeneration end condition is established, controlling the charging/discharging unit to perform the charging operation when the regeneration end condition is established, and determining a degree of degradation of the power storage unit, based on a value of a voltage of the power storage unit and a current value flowing through the power storage unit during at least one of the regeneration operation and the charging operation performed after the regeneration operation.

2.-4. (canceled)

5. The power supply control device according to claim 1,
wherein the control unit controls the charging/discharging unit to perform the regeneration operation, such that a discharge current from the charging/discharging unit is constant, and determines the degree of degradation of the power storage unit, based on the value of the voltage of the power storage unit and the value of the current flowing through the power storage unit during the regeneration operation.

6. The power supply control device according to claim 1,
wherein the control unit controls the charging/discharging unit to perform the charging operation, such that a charge current from the charging/discharging unit is constant, and determines the degree of degradation of the power storage unit, based on the value of the voltage of the power storage unit and the value of the current flowing through the power storage unit during the charging operation.

7.-11. (canceled)
